(19) United States
(12) Patent Application Publication
(10) Pub. No.: US 2013/0007667 A1
(43) Pub. Date: Jan. 3, 2013

(54) PEOPLE CENTRIC, CROSS SERVICE, CONTENT DISCOVERY SYSTEM

(75) Inventors: Aaron Sauve, Seattle, WA (US); Jannes Paul Peters, Seattle, WA (US); Marc David McClure, Seattle, WA (US); Kathryn Lemson, Redmond, WA (US); Divya Tyamagundlu, Bellevue, WA (US); Ian Middleton, Bellevue, WA (US); Sushil Kumar, Bellevue, WA (US); Peter Bohac, Issaquah, WA (US); Aravind Narayanan Manimandiram, Redmond, WA (US); Gary Daniels, Duvall, WA (US); Jonathan Gass, Seattle, WA (US)

(73) Assignee: MICROSOFT CORPORATION, Redmond, WA (US)

(21) Appl. No.: 13/170,293

(22) Filed: Jun. 28, 2011

(51) Int. Cl. G06F 3/048

(52) U.S. Cl. 715/838

(57) ABSTRACT

A menu structure is provided which allows a user of a computing device to more easily consolidate and navigate images and/or albums regardless of their location. Moreover, the menu structure is dynamically tailored to individual users based on their previous interactions with the people appearing in the images/albums. The menu includes icons representing images (e.g., photos) or collections of images that have been categorized based in part on metadata respectively associated with the images. The metadata may have been provided by tagging the images or posting the images on one or more social networking sites. The order in which the icons are presented on the menu or interface may be based on their relative relevance or importance to the user.

### BACKGROUND

As computing and digital imaging technology has advanced, computing devices have become an increasingly popular platform for managing, viewing, and sharing photographs, video, and other images. To allow users to more efficiently organize and locate images, mechanisms have been developed that automatically organize documents based at least in part upon metadata pertaining to the documents. Thus, for instance, if an image was captured when a user was on vacation at a particular location, the user can assign a tag to the image that indicates dates of the vacation, name of the location, etc. The tag serves as user-defined metadata. Thereafter, to locate a particular image, the user can search using a query that corresponds to metadata assigned to one or more images, and the search can be undertaken over the metadata assigned to the images.

Another mechanism that has been developed to add metadata to images involves the posting of images. When a user posts an image or album on a server hosted by a social media service so that it can be shared with others, metadata is added which allow user to locate the image or album.

Despite the use of tagging and posting, problems remain when users attempt to discover, locate and organize images. This is particularly true as the number of images accessible to users continues to grow at a rapid rate, which is in part due to the growth of social networking sites, which allow users to view, publish and share images and other digital assets with their friends, other contacts and third parties. Accordingly, it can be cumbersome for a user to navigate images even when they have been tagged with metadata, especially when some of the images may be locally stored on the user's computing device and other images may be located on remote sites which make them available through various services. This problem is further exacerbated when some of the images have been tagged by the user and other images have been tagged by other individuals.

### SUMMARY

A method and system is provided which dynamically adjusts the manner in which photos, photo albums and other images are made accessible and presented or otherwise exposed to a user of a computing device, regardless of the location or service from which the images are accessed. For instance, the photos may be locally accessible on the computing device or remotely accessible from a social networking service, for example. The manner in which the adjustments are made is tailored to the user based on the user's previous activities in connection with the photos, the individual or group of individuals appearing in the photos and photo albums, and the person who posted the photos or albums

The photos and photo albums may be accessed through various organizational structures tailored to the user's previous experience with the people, photos, and photo albums available on the computing device. For instance, icons representing collections of photos or the individual photos themselves may be displayed in a manner that reflects the relative relevance or importance to the user of the individual or group of individuals in the collection of photos represented by each icon. In one implementation, both the order in which the icons are presented as well as their appearance may reflect the relative relevance or importance to the user of the individual or group of individuals in the collection of photos represented by each icon. In this way the user can more easily navigate through the icons and the photos and albums.

Sorting the icons based on the relative importance of the individual or group of individuals appearing in the photos may be accomplished in a number of different ways. In one implementation, if a user accesses (e.g., views, shares, and/or tags) photos or photo albums posted by a particular person the prominence of icons representing all the available photos and photo albums of that person will increase overall. That is, all photos and photo albums showing an individual or group of individuals who photos and photo albums has been the most accessed by the user may be considered as the most important, while those photos and photo albums showing an individual or group of individuals whose photos or photo albums has been the least accessed by the user may be considered as the least important. As a concrete example, if an individual photo of a particular person is accessed say, 100 times, the prominence of icons representing all that person's collections of photos which are available to the user is increased. This is because the relevance or importance of that particular person has increased as a result of accessing even a single one of his or her photos so many times. In this way the icons may be presented to the user in a sequential order that reflects the relative degree to which the user has previously interacted with the photos and photos albums of the individual or group of individuals.

In one illustrative example a menu or interface is presented to the user. The menu or interface includes icons representing images (e.g., photos) or collections of images that have been categorized based in part on metadata respectively associated with the images. The metadata may have been provided by tagging the images or posting the images on one or more social networking sites. The order in which the icons are presented on the menu or interface may be based on their relative relevance or importance. In one particular implementation, icons representing collections of images showing an individual or group of individuals whose images are more frequently accessed can be displayed in the menu before (e.g., higher than) icons representing collections of images showing an individual or group of individuals who images are less frequently accessed. In yet another implementation, collections of images showing an individual or group of individuals whose images have been more recently accessed can be displayed before (e.g., higher than) icons representing other collections showing an individual or group of individuals who images have been less recently accessed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows one example of an operating environment in which the processes for organizing photos and other images described herein may be implemented.

FIG. 2 shows a top level menu of a logical hierarchy of digital assets and other items available on a computing device such as the computing device shown in FIG. 1.

FIGS. 3-8 show other examples of menus or interfaces that may be available on a computing device such as the computing device shown in FIG. 1.

FIG. 9 is a flowchart showing an example methodology that facilitates organizing images based at least in part upon tags assigned thereto.

FIG. 10 is a high-level illustration of an example computing device that can be used in accordance with the systems and methodologies disclosed herein.

### DETAILED DESCRIPTION

As detailed below, a menu structure is provided which allows a user of a media or computing device to more easily consolidate and navigate images and/or albums (“images/albums”) regardless of their location. Moreover, the menu structure is dynamically tailored to individual users based on their previous interactions with the images/albums. This structure allows users to discover and access images/albums in different ways which offer a personalized experience to the user.

It should be noted at the outset that while from time to time reference is made herein to photos, those of ordinary skill in the art will recognize that the systems, methods and techniques herein are equally applicable to images of all types and not just photographic images. Although images and albums are primarily discussed herein, it is to be appreciated that the techniques discussed herein can also be used with collections or sequences of images (e.g. videos), including sequences of images that may appear in albums.

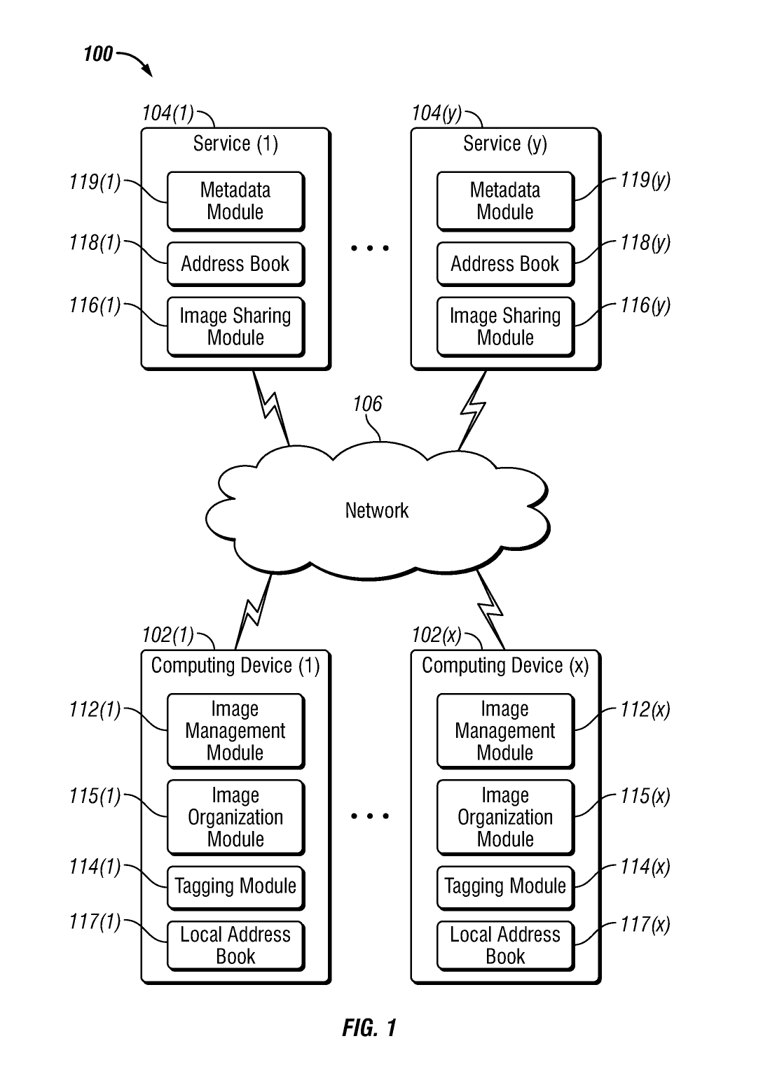

FIG. 1 shows one example of an operating environment in which the processes for organizing photos and other images described herein may be implemented. A system 100 includes one or more (x) computing devices 102 that can communicate with one or more (y) services 104 via a network 106. Network 106 can be a variety of different networks, including the Internet, a local area network (LAIN), a public telephone network, a cellular or other wireless phone network, an intranet, other public and/or proprietary networks, combinations thereof, and so forth.

Each computing device 102 can be a variety of different types of devices. For example, a computing device 102 can be a desktop computer, a mobile station, an entertainment appliance, a set-top box communicatively coupled to a display device, a cellular or other wireless phone, a personal digital assistant (PDA), a game console, an automotive computer, and so forth. Thus, each computing device 102 can range from a full resource device with substantial memory and processor resources (e.g., personal computers, game consoles) to a low-resource device with limited memory and/or processing resources (e.g., traditional set-top boxes, hand-held game consoles). Different computing devices 102 can be the same type or alternatively different types of devices.

Services 104 can be provided by a variety of different types of computing devices. For instance, each service may be provided through one or more servers.

Each computing device 102 includes an image management module 112, a tagging module 114, an image organization module 115 and a local address book 117. Image management module 112 manages images on computing device 102, including the storage, retrieval, display, communication, and so forth of images. Images can be stored by computing device 102 locally, or alternatively on a remote storage device. Tagging module 114 assists users in tagging images, allowing names or labels to be associated with particular images and/or regions of images as discussed in more detail below. Image organization module 115 can organize images and their tags and provide the various menus and interfaces discussed below into which the images are organized based on those tags. The local address book 117 allows users to maintain a list of contacts.

Server 104 includes an image sharing module 116, address book 118 and metadata module 119. Image sharing module 116 manages the storing and sharing of images by server 104. Image sharing module 116 works in conjunction with the address book 118 and the metadata module 119 to perform these functions. Users of various computing devices 102 can access and view images managed by image sharing module 116, as discussed in more detail below.

In one or more embodiments, image sharing module 116 supports a social networking service, allowing multiple users to communicate with one another and share their images/albums with one another.

Images/albums may include metadata, which, among other things, identifies individuals or groups of individuals shown in the images/albums. While the metadata may be incorporated in accordance with any technique available to those of ordinary skill in the art, two examples discussed herein include the tagging of photos and the posting of photos so that they can be shared with others. Each of these techniques will be discussed in turn.

Images/albums are typically tagged by a user of a computing device 102 via tagging module 114. The image can then be viewed by a user of computing device 102. Additionally, the image can then be communicated to server 104 and image sharing module 116 allows other users to view the image (and associated tags). This allowing of other users to view the image is also referred to as publishing the image.

Tagging images refers to associating metadata such as a particular label with an image or a portion (referred to as a region) of an image. These labels are discussed herein primarily as names of people in images. Accordingly, images that incorporate metadata in this manner can be referred to as tagged images which are tagged with the names of individuals or groups of individuals. Alternatively, labels for other objects can be supported (e.g., my house, the Statue of Liberty, Pacific Ocean, and so forth) analogous to the names discussed herein.

Tags can be global tags or region-specific tags. A global tag is associated with an entire image. For example, a global tag with the name “Bob” can be associated with an image, indicating that a person named “Bob” is included in the image. A region-specific tag, also referred to as a region tag, is associated with a portion or region of an image. For example, a region tag with the name “John” can be associated with a particular region of the image, indicating that a person named “John” is included in that region of the image.

Once published by image sharing module 116, other users can also tag the image via the tagging module 114 on the computing devices 102 they are using. These additional tags are added to the image so that they can be viewed by other users, including the user that had the image published.

Tagging module 114 presents a user interface that allows users of computing device 102 to tag photos in accordance with any of a variety of well-known techniques. For instance, a tag typically includes a label or name of a person included in the image, and can also include one or more additional identifiers of the person. In one or more embodiments, image sharing module 116 is part of an online service that users join. As part of this service, users are assigned an identifier (ID) that typically uniquely identifies the user within that service. This ID can be stored as part of the tag. Additionally, in one or more embodiments an email address of the user (or other value based on the email address, such as a hash value generated by applying a hash function to the email address) is stored as part of the tag. These one or more additional identifiers can be used to distinguish between different users that are named in the tags, as discussed in more detail below. These IDs and email addresses can be stored by address book 118, or alternatively by other services, components, and/or modules.

The ID and/or email address (or hash thereof) is typically added to the tag when the tag is created. This information can be obtained in a variety of different ways, such as by accessing address book 118, by being manually input by the user, and so forth. In some cases, a list of possible people to tag an image with can be displayed to the user. This list can be obtained from, for example, address book 118. The people included in this list may be referred to as contacts of the user, and an ID and/or email address has typically already been input by the user (or another), and can be copied form this contact information to the tag.

As previously mentioned, in addition to tagging, metadata may also be incorporated into images/albums by posting them on a server or other device that allows them to be shared with others. For instance, images/albums may be posted on a social networking site. Generally these sites provide APIs that allows a user who accesses the posted image/album to access metadata that indicates the identity of the person who posted the image/album.

In summary, photos that are either tagged with information or posted to a service will include metadata which allows the individual who is in the image/album or the individual who posted the image/album to be identified. Such images/albums will be referred to herein as images/albums that relate to the individual respectively identified in the metadata associated with the images/albums.

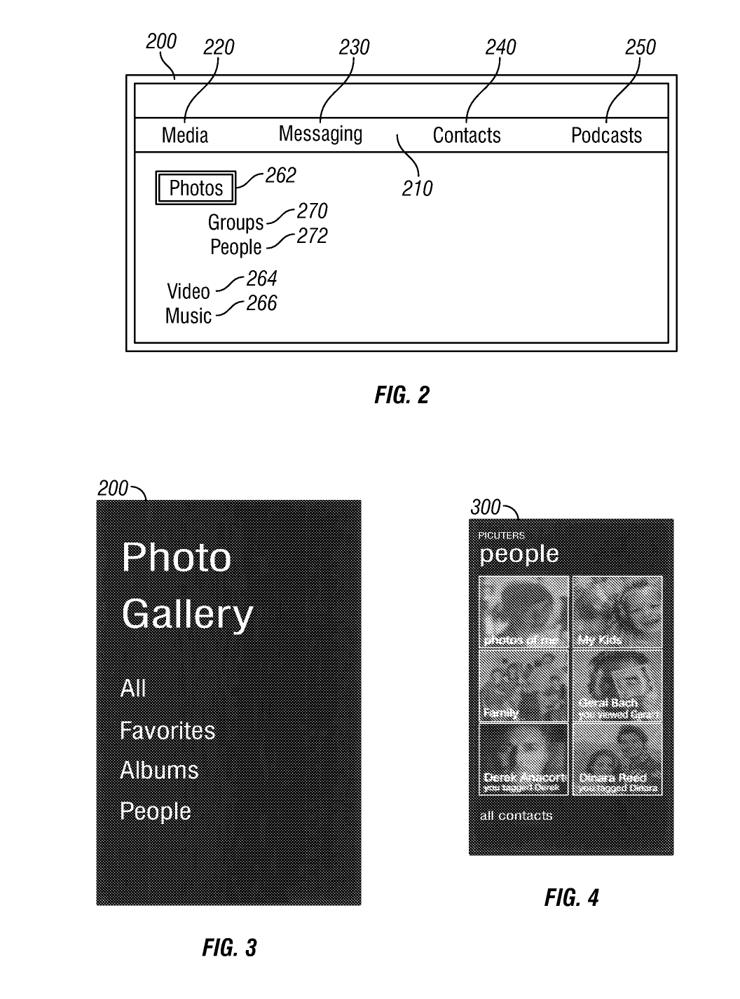

FIG. 2 shows a top level menu 200 of a logical hierarchy of digital assets and other items available on the computing device 102. In some cases the menu can he implemented in processes performed by a utility that is built into the operating system of the computing device 102. In other cases the menu may be implemented by processes performed by an application executing on the computing device 102. The menu 200 includes the names of different categories 210 of digital assets such as media 220, messaging 230, contacts 240 and podcasts 250, for instance.

When a user selects one of the categories 210 its various sub-categories are presented below it. For instance, in FIG. 2 the user has selected the media category 220 and the subcategories, which may be referred to as media hubs, may include, for instance, a photo hub 262, video hub 264 and music hub 266. If the user selects the photo hub 262, an interface or menu is presented to the user which offers a further subcategory, which in this case is a consolidated view of photos and other images regardless of where they are located on either the computing device 102 or a remote server such as server(s) 104. Two additional subcategories are shown under the photo hub 162. These subcategories may be referred to as libraries and in this example are designated as the groups and people libraries.

It should be noted that the particular categories and subcategories depicted in FIG. 2 and the figures that follow is shown for illustrative purposes only and may be reorganized in any convenient manner. For instance, as will be described below in connection with FIG. 3, the groups library of FIG. 2 is subsumed into the people library.

FIG. 3 shows one example of a menu or interface 200 for the photo hub 262. The interface 200 may be provided by an image organization module such as the image organization module 115 that is included in the computing device 102 of FIG. 1. Interface 200 functions as a photo gallery that is an entry point allowing users to navigate through photos that may be organized in a variety of different ways. For example, as shown, the illustrative photo gallery or hub interface 200 includes a number of different libraries that each categorize photos in a different way. In this example the illustrative libraries include libraries of favorites, albums and people.

If the user selects the people library shown in FIG. 3, the image organization module 115 presents another interface to the user. This interface includes a series of icons that each represent a collection of images/albums which have metadata identifying the name of an individual who may be, for example, a contact in the user's address book or some other third party. Other icons in the menu or interface for the people library may represent a collection of photos which have metadata that identifies the name of a group of individuals. The groups may be predefined by the user as desired. In other words, in the people library photos are sorted into categories in accordance with the name of an individual or group of individuals specified in the metadata associated with each photo. As previously mentioned in connection with FIG. 2, in some implementations the collections of photos designated as groups may be assigned their own library instead of being incorporated into the people library.

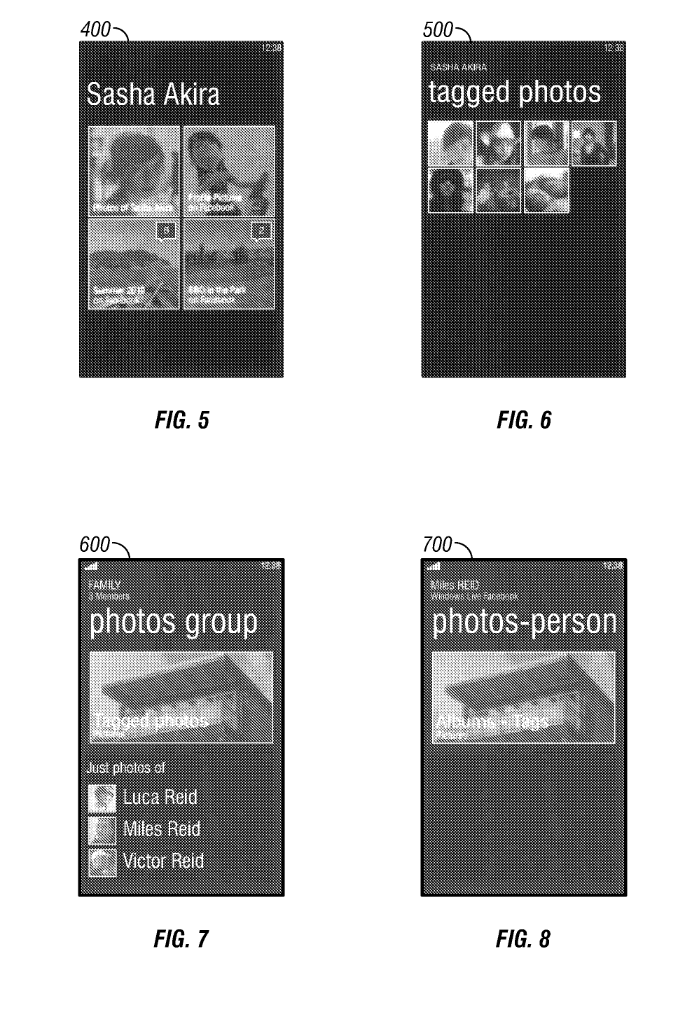

FIG. 4 shows one example of a menu or interface 300 that may be associated with the people library of FIG. 3. The interface 300 serves as an entry point to subcategories of tagged images below or within the people library. This example shows six icons that represent different collections of photos which have been sorted by the names of three individuals (i.e., Geral Bach, etc), two groups (My Kids, Family) and a collection of photos that have been tagged to specify the user him- or herself (Photos of Me). Each icon is a user-selectable link that allows the user to view the images/albums in its respective collection. For instance, by selecting an icon specifying a particular contact, another interface such as shown in FIG. 5 is presented to the user. In the particular example of FIGS. 4 and 5 the icons are thumbnail photos selected from the collection of images/albums with which the icons are respectively associated. As shown, the icons also include an indentifier that identifies the collection of photos. In FIG. 4 and the figures that follow, the identifier is text-based and corresponds to a portion of the metadata associated with the images/albums in the collection. Also included in the interface of FIG. 4 is a link through which the user can access images of other individuals which otherwise would not be available from this menu.

In the example shown in FIG. 5 the menu or interface 400 represents a contact of the user named Sasha Akira. The contact interface 400 presents additional icons that are user-selectable links that allow the user to view the photos of the contact, which themselves may be sorted into different categories, which in some cases may represent albums of photos that have been assembled by the contact. For instance, in FIG. 5 the albums “Summer 2010” and “BBQ? in the Park” are shown. These albums have been identified by metadata that was provided when the albums were posted so that they could be shared with others.

Referring again to the interface 300 to the people library of FIG. 4, the icons representing different collections of photos are displayed in a manner that is tailored to the user based on the user's previous activities in connection with the individual or group of individuals identified by the metadata in the photos. For instance, the icons may be displayed in a manner that reflects the relative relevance or importance to the user of the individuals or group of individuals identified in the photo collections represented by each icon. Sorting the icons based on their relative relevance or importance may be accomplished in a number of different ways. For instance, icons representing collections of images showing an individual or group of individuals whose images/albums are most frequently accessed (e.g., viewed, shared, and/or tagged) by the user may be considered as the most important, while those icons representing collections of images showing an individual or group of individuals whose images/albums have been the least accessed (e.g., viewed, shared, and/or tagged) by the user may be considered as the least important. In this way the icons may be presented in a sequential order that reflects the relative degree of prior user interaction with the images/albums of those individuals or groups of individuals.

The frequency with which the images/albums have been accessed by the user can be recorded by the image organization module 115 shown in FIG. 1, which can use this information to prioritize the images/albums and collections of images/albums and generate the menus and interfaces which are presented to the user in a manner that reflects the order in which the images and collections of images have been prioritized.

The record of the user's prior activity relating to the images can be used in a variety of different ways to determine the order in which the icons are presented on the menu or interface 300 based on their relative importance. For example, icons representing collections of images/albums which have metadata identifying individuals or groups of individuals whose images/albums are more frequently accessed can be displayed in the interface 300 before (e.g., higher than) icons representing images/albums which have metadata identifying individuals or groups of individuals whose images/albums are less frequently accessed. By way of another example, icons representing collections of images/albums which have metadata identifying individuals or groups of individuals whose images/albums have been more recently accessed can be displayed before (e.g., higher than) the icons representing other collections of images/albums which have metadata identifying individuals or groups of individuals whose images/albums have been less recently accessed.

In addition to displaying the icons included in the interface 300 for the people library in a manner that reflects their relative relevance or importance, the icons included in the contact interface 400 of FIG. 5 may also be displayed in a manner which is based on the user's previous activities in connection with the photos represented by each of the icons. In other words, the collections of photos relating to the contact (e.g., Sasha Akira) can be displayed in an order that reflects their relative importance to the user. The icons may also be ordered and displayed in other ways such as by the date when they were tagged. For instance, in one example, all newly tagged photos from all locations can be exposed or displayed to the viewer.

When the user selects an icon from the interface 400 for a contact, yet another interface is presented to the user. This interface shows all the images related to that contact which are included in the particular collection of photos represented by the selected icon. For instance, if the user selects the icon in FIG. 5 which is designated “Photos of Sasha Akira,” then the interface 500 shown in FIG. 6 may be presented. In this case the icons are thumbnails of the individual photos which are included in this collection. As with the icons shown in FIGS. 4 and 5, the icons included in the interface 500 of FIG. 6 may be displayed in a manner that reflects prior user activity in connection with the photos and the individuals in the photos. As previously mentioned, the images/albums presented by the menu or interface 500 of FIG. 6 may be locally stored by the user and/or available to the user across multiple social networks.

he particular hierarchical menu structure described above is presented for illustrative purposes only and may be rearranged in a myriad of ways without departing from the scope or spirit of the claimed subject matter. In addition, the menu structure may be supplemented with additional menus or interfaces that allow users to gain access to the various library of images described above. For instance, FIG. 7 shows an additional menu or interface 600 that is assigned by the user to a particular group of individuals. In this example the menu provides access to all photos for the group designated “Family.” For convenience, this interface also provides links to the photos of the individual members of the group. Similarly, FIG. 8 shows an additional menu or interface 700 that is assigned to a particular one of the user's contacts, This interface 700 serves as an entry point to all images having metadata that identifies the contact.

In some implementations additional links may be provided that allow users to access images/albums of individuals in additional ways as well, thereby further enhancing the user's ability to navigate through images. For instance, in one particular implementation a user is able to click on or otherwise select an individual appearing in an image and directly access other images/albums of that individual.

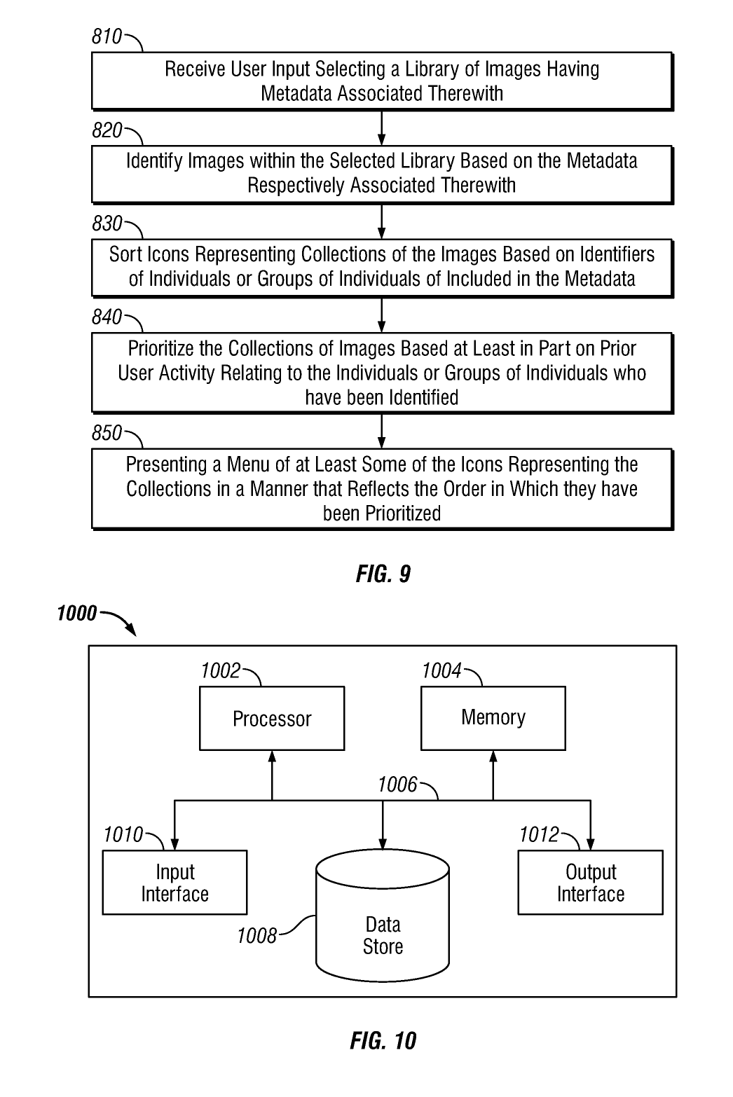

FIG. 9 is a flowchart showing an example methodology that customizes the accessibility of images/albums available to a user locally or remotely based at least in part on the identity of individuals or groups of individuals as determined from metadata associated with the images/albums. The method begins at step 810 when the media or computing device receives input from a user selecting a library of images/albums that have metadata associated therewith. Some of the images/albums may be located on one or more remote servers with which the computing device communicates while other images/albums may be locally stored on the media or computing device. In response to the user input, at step 820 images/albums within the selected library are identified based on the metadata respectively associated therewith. Icons representing collections of the images/albums are sorted at step 830 based on identifiers of individuals or groups of individuals included in the metadata. The collections of images are prioritized at step 840 based at least in part on prior activity of the user relating to the individuals or group of individuals who have been identified by the identifiers. A menu is presented to the user at step 850. The menu includes at least some of the icons representing the collections of images in a manner that reflects the order in which they have been prioritized.

Now referring to FIG. 10, a high-level illustration of an example computing device 1000 that can be used in accordance with the systems and methodologies disclosed herein is illustrated. For instance, the computing device 1000 may be used in a system that supports organizing, viewing and/or editing documents such as the computing device 102 shown in FIG. 1. In another example, at least a portion of the computing device 1000 may be used in a system that supports sharing of images by the services 104 shown in FIG. 1. The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store contact data, digital assets such as images, documents and tags, etc.

The computing device 1000 additionally includes a data store 1008 that is accessible by the processor 1002 by way of the system bus 1006. The data store 1008 may include executable instructions, people tags, documents, etc. The computing device 1000 also includes an input interface 1010 that allows external devices to communicate with the computing device 1000. For instance, the input interface 1010 may be used to receive instructions from an external computer device, from an individual, etc. The computing device 1000 also includes an output interface 1012 that interfaces the computing device 1000 with one or more external devices. For example, the computing device 1000 may display text, images, etc. by way of the output interface 1012. Additionally, while illustrated as a single system, it is to be understood that the computing device 1000 may be a distributed system. Thus, for instance, several devices may be in communication by way of a network connection and may collectively perform tasks described as being performed by the computing device 1000.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of customizing access to images available to a user on a computing device, comprising:
receiving input from a user selecting a library of images having metadata associated therewith, said images being accessible on the computing device, and at least some of which are provided by one or more services with which the computing device communicates;
identifying images within the selected library based on the metadata respectively associated therewith;
sorting icons that represent a plurality of collections of the images that have been identified, each of the collections being sorted using an identifier of an individual or a group of individuals included in the metadata associated with the images;
prioritizing the collections of images based at least in part on prior user activity relating to images of the individual or group of individuals who has been identified; and
presenting to the user a menu of at least some of the icons representing the plurality of collections of the images in a manner that reflects an order in which the collections have been prioritized.

2. The method of claim 1 in which prioritizing the collections of images includes prioritizing the collections of images based at least in part on a frequency with which the images of the individual or group of individuals have been previously viewed, shared and/or tagged by the user.

3. The method of claim 2 in which presenting the menu to the user includes presenting icons with a higher priority higher in a sequence than icons with a lower priority,

4. The method of claim 1 in which at least one of the icons is an image selected from the collection of images that it respectively represents.

5. The method of claim 4 further comprising displaying an identifier associated with each of the icons identifying the collection of images respectively represented by the icon.

6. The method of claim 1 in which the one or more services are social networking services and the images include images that have been shared by contacts of the user using the one or more social networking services.

7. The method of claim 1 in which prioritizing the collections of images includes prioritizing the collection of images based at least in part on how recently images of individuals or groups of individuals identified in the collection of images have been previously viewed, shared and/or tagged by the user.

8. The method of claim 1 further comprising:
receiving user input accessing at least one of the images within the selected library; and
re-prioritizing the collections of images within the selected library to account for user activity accessing said at least one of the images.

9. The method of claim 1 in which the metadata is provided by tagging or posting the images.

10. The method of claim 1 in which the metadata associated with at least a first of the images is provided by tagging the first image and the metadata associated with at least a second of the images is provided by posting the second image.

11. A computer-readable medium comprising instructions that, when executed by a processor, cause the processor to perform acts comprising:
organizing images into a logical hierarchy of categories based on metadata respectively associated with each of the images, said logical hierarchy of categories including at least a first category and at least a first subcategory therebelow, in which at least some of the images are images shared with a user by a third party via one or more social networking services; and
in response to a request from the user, presenting a menu that includes icons from which the images in the first subcategory can be selected, said icons being presented in a sequence that reflects relative degrees of prior user interaction with images of individuals or groups of individuals identified by the metadata.

12. The computer-readable medium of claim 11 in which the first category includes a plurality of collections of images having metadata identifying contacts of the user and the first subcategory includes images having metadata identifying one particular contact.

13. The computer-readable medium of claim 11 in which the first category includes a plurality of collections of images having metadata identifying a group of individuals and the first subcategory includes images having metadata identifying one particular group of individuals.

14. The computer-readable medium of claim 11 further comprising prioritizing the images in a sequential order based at least in part on a frequency with which images relating to the individual or group of individuals have been previously viewed, shared and/or tagged by the user and presenting the icons associated with the images in the sequential order.

15. The computer-readable medium of claim 13 further comprising prioritizing the images based at least in part on how recently images relating to the individual or group of individuals have been previously viewed, shared and/or tagged by the user.

16. The computer-readable medium of claim 11 in which at least one of the icons is a thumbnail image selected from a collection of images with which it is respectively associated and further comprising displaying an identifier associated with each of the icons identifying the collection of images respectively represented by the icon.

17. The computer-readable medium of claim 11 further comprising:
receiving user input accessing at least one of the images within the first subcategory; and
re-prioritizing the icons within the first subcategory so that they are presented to the user in a sequence that accounts for user activity accessing said at least one of the images.

18. A computing device, comprising:
a memory for storing instructions;
a processor for executing instructions stored in the memory to cause the computing device to perform operations including:
receiving input from a user selecting a library of images having metadata associated therewith, said images being accessible on the computing device, and at least some of which are provided by one or more services with which the computing device communicates;
identifying images within the selected library based on the metadata respectively associated therewith;
sorting icons that represent a plurality of collections of the images that have been identified, each of the collections being sorted using an identifier of an individual or a group of individuals included in the metadata associated with the images;
prioritizing the collections of images based at least in part on prior user activity relating to images of the individual or group of individuals who has been identified; and
presenting to the user a menu of at least some of the icons representing the plurality of collections of the images in a manner that reflects an order in which the collections have been prioritized.

19. The computing device of claim 18 in which prioritizing the collections of images includes prioritizing the collections of images based at least in part on a frequency with which the images of the individual or group of individuals have been previously viewed, shared and/or tagged by the user.

20. The computing device of claim 18 in which the processor executes instructions stored in the memory to cause the computing device to perform operations further comprising:
receiving user input accessing at least one of the images within the selected library; and
re-prioritizing the collections of images within the selected library o account for user activity accessing said at least one of the images.
